(19) United States
(12) Patent Application Publication
(10) Pub. No.: US 2019/0036403 A1
(43) Pub. Date: Jan. 31, 2019

(54) MOTOR

(71) Applicant: NIDEC CORPORATION, Minami-ku Kyoto (JP)

(72) Inventors: Tomoyuki UMEDA, Minami-ku Kyoto (JP); Takayuki MIGITA, Minami-ku Kyoto (JP)

(21) Appl. No.: 16/148,191

(22) Filed: Oct. 1, 2018

Related U.S. Application Data
(63) Continuation of application No. PCT/JP2017/003548, filed on Feb. 1, 2017.

(30) Foreign Application Priority Data
Mar. 31, 2016 (JP) 2016-070269

(51) Int. Cl. H02K 1/28; H02K 1/32; H02K 5/173; H02K 5/22; H02K 7/08; H02K 7/14; H02K 11/30; H02K 21/16; F04D 19/00; F04D 29/18

(52) U.S. Cl. CPC H02K 1/28; H02K 1/32; H02K 5/1732; H02K 5/225; H02K 7/083; H02K 2211/03; H02K 11/30; H02K 21/16; F04D 19/002; F04D 29/181; H02K 7/14

(57) ABSTRACT

A motor may include a rotor that rotates on a central axis; and a stator that is located radially outside the rotor. The rotor may include a rotor core; and a resin portion that is provided to cover at least a part of the rotor core. The rotor core has a plurality of through-holes that penetrate the rotor core in an axial direction. The resin portion may include a first resin portion that is provided to cover at least a part of an axially first-side end face of the rotor core; and an extension that is provided in at least one of the through-holes and extends from the first resin portion through the through-hole in the axial direction. The first resin portion may include a protrusion that protrudes toward an axially first side. The protrusion and the extension may overlap with each other as seen in axial plan view.

This application is a bypass continuation application of PCT Application No. PCT/JP2017/003548, filed Feb. 1, 2017, and claims the benefit of priority to Japanese Patent Application No. 2016-070269 filed on Mar. 31, 2016. The entire contents of each application are hereby incorporated herein by reference.

### FIELD

The present disclosure relates to a motor.

### BACKGROUND

Recently, a motor and a controller that controls the motor have been assembled into a single unit for the purpose of miniaturization. The unit into which the motor and the controller are assembled has a short distance between the motor and a control circuit board in the controller. Consequently, heat to be generated in driving the motor may adversely affect the operation of the controller.

For example, a known motor of an inner rotor type is cooled by means of an air flow to be generated upon rotation of a rotor.

The impeller is mounted to a rotor core, which may cause an increase in heat capacity as the entire rotor. As a result, heat is less prone to being released from the interior of the motor. In addition, since the impeller is mounted to the rotor, wobbling may occur at the impeller relative to the rotor if an impeller mount region of the rotor is poor in stiffness.

### SUMMARY

An exemplary motor includes: a rotor that rotates on a central axis; and a stator that is located radially outside the rotor. The rotor includes: a rotor core; and a resin portion that is provided to cover at least a part of the rotor core. The rotor core has a plurality of through-holes that penetrate the rotor core in an axial direction. The resin portion includes: a first resin portion that is provided to cover at least a part of an axially first-side end face of the rotor core; and an extension that is provided in at least one of the through-holes and extends from the first resin portion through the through-hole in the axial direction. The first resin portion includes a protrusion that protrudes toward an axially first side. The protrusion and the extension overlap with each other as seen in axial plan view.

The above and other elements, features, steps, characteristics and advantages of the present disclosure will become more apparent from the following detailed description of the embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic plan view of an electric fan according to an exemplary embodiment.

FIG. 2 is a schematic side view of the electric fan according to the exemplary embodiment.

FIG. 3 is a schematic perspective view of a motor according to the exemplary embodiment.

FIG. 4 is a schematic sectional view of the motor according to the exemplary embodiment.

FIG. 5 is a schematic perspective view of a rotor core according to the exemplary embodiment.

FIG. 6 is a schematic perspective view of the rotor core and a plurality of magnets according to the exemplary embodiment.

FIG. 7 is a schematic perspective view of a rotor according to the exemplary embodiment as obliquely seen from an axially first side.

FIG. 8 is a schematic perspective view of the rotor according to the exemplary embodiment as obliquely seen from an axially second side.

FIG. 9 is a schematic plan view of the rotor according to the exemplary embodiment as seen from the axially first side.

FIG. 10 is a schematic sectional view taken along line X-X in FIG. 9.

### DETAILED DESCRIPTION

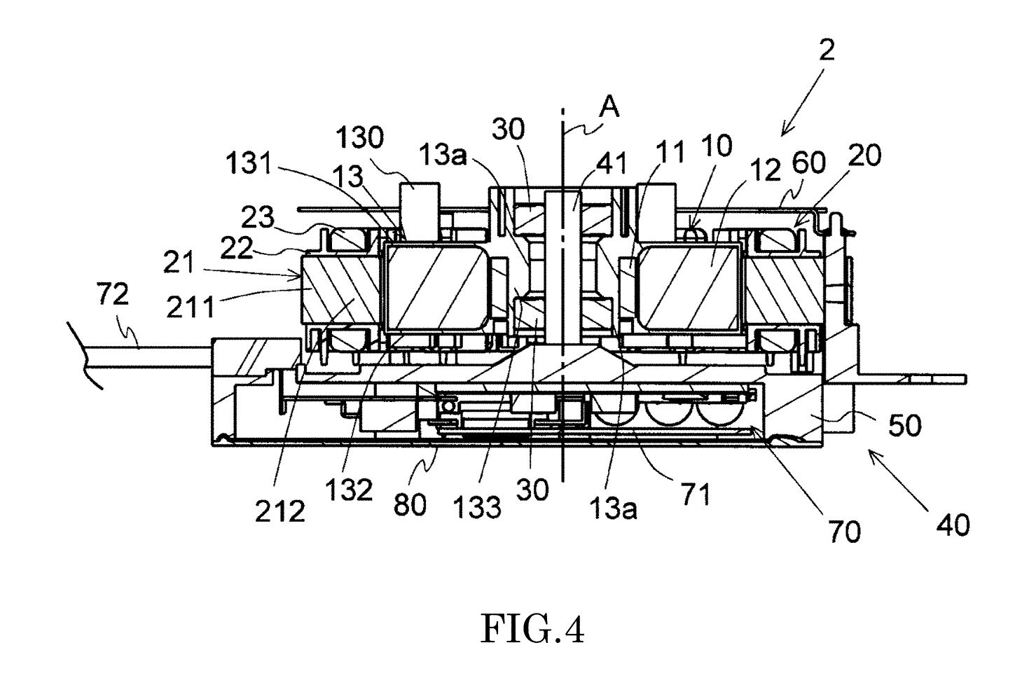

With reference to the drawings, a specific description will be given of a motor according to the present disclosure. As used herein, the terms “axial direction”, “axial”, and “axially” each represent a direction along which a central axis A of a motor (see FIG. 4) extends. In addition, the terms “radial direction”, “radial”, and “radially” and the terms “circumferential direction”, “circumferential”, and “circumferentially” respectively represent a radial direction from the central axis A of the motor and a circumferential direction about the central axis A of the motor. The same applies for an impeller to be mounted to the motor.

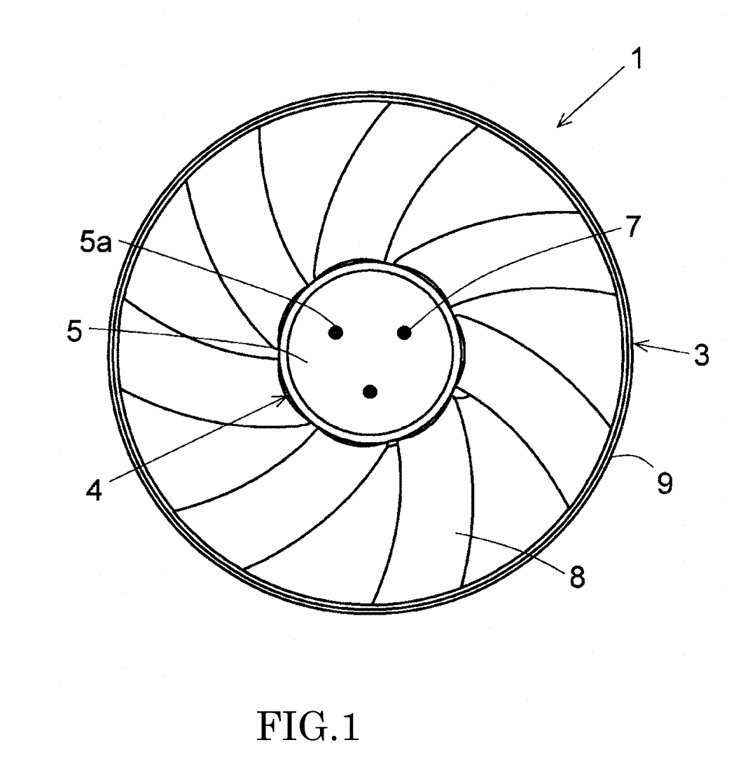

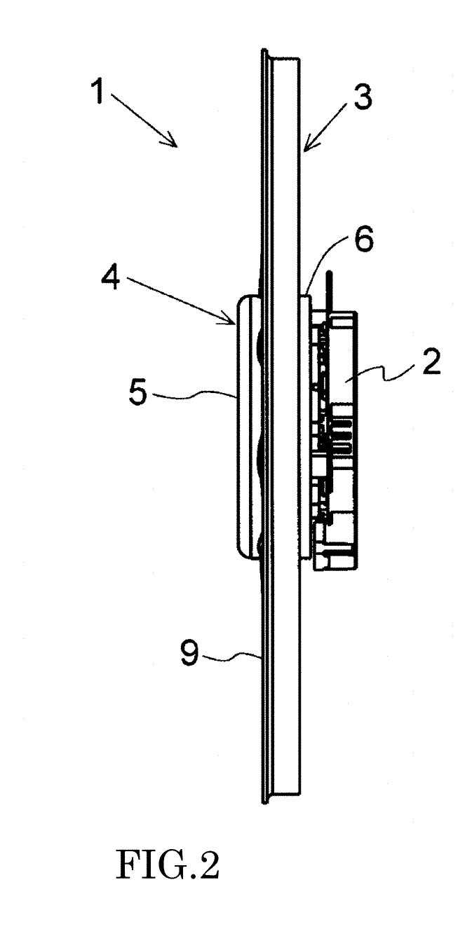

FIG. 1 is a schematic plan view of an electric fan 1 according to the present embodiment. FIG. 2 is a schematic side view of the electric fan 1 according to the present embodiment. The electric fan 1 includes a motor 2 and an impeller 3. The motor 2 has protrusions 130 (to be described later). The impeller 3 is mounted to the motor 2 via the protrusions 130. In the present embodiment, the impeller 3 is directly mounted to the protrusions 130. Alternatively, the impeller 3 may be indirectly mounted to the protrusions 130. The impeller 3 is disposed on one side of the motor 2 in the axial direction and rotates on the central axis A. In the following description, a side, on which the impeller 3 is disposed, of the motor 2 is referred to as an axially first side, and the opposite side is referred to as an axially second side.

The impeller 3 includes a tubular portion 4 whose axially first side is closed. The tubular portion 4 is provided to cover at least a part of the motor 2 from a radially outer side of the motor 2. In the present embodiment, the tubular portion 4 includes a disk portion 5 that expands in a direction perpendicular to the axial direction. The disk portion 5 is located on an axially first-side end of the tubular portion 4. The tubular portion 4 includes a cylindrical portion 6 that extends from the disk portion 5 toward the axially second side. The cylindrical portion 6 is located radially outside the motor 2. The central axis A of the motor 2 coincides with the center of the disk portion 5 as seen in axial plan view.

The disk portion 5 has a plurality of screw holes 5a that are located radially outside the center of the disk portion 5. Each of the screw holes 5a penetrates the disk portion 5 in the axial direction. In the present embodiment, the number of screw holes 5a is three. The three screw holes 5a are arranged at equal intervals in the circumferential direction. A screw 7 is inserted into each screw hole 5a. The screws 7 are respectively mounted to the protrusions 130 of the motor 2. The disk portion 5 is secured to the motor 2 with the screws 7, so that a part of the motor 2 in the axial direction is covered with the cylindrical portion 6.

The impeller 3 includes a plurality of blades 8 that are disposed on an outer periphery of the tubular portion 4 and are arranged in the circumferential direction. The blades 8 are arranged at equal intervals in the circumferential direction. Each of the blades 8 extends radially outward from the cylindrical portion 6. The impeller 3 includes a ring portion 9 that is connected to a radially outer end of each blade 8, at a radially outer side of each blade 8. In the present embodiment, the blades 8 are integrated with the tubular portion 4 and the ring portion 9. In the present embodiment, the number of blades 8 is seven. However, these configurations are merely exemplary. For example, the tubular portion 4, the blades 8, and the ring portion 9 may be separated from one another. In addition, the number of blades 8 may be appropriately changed.

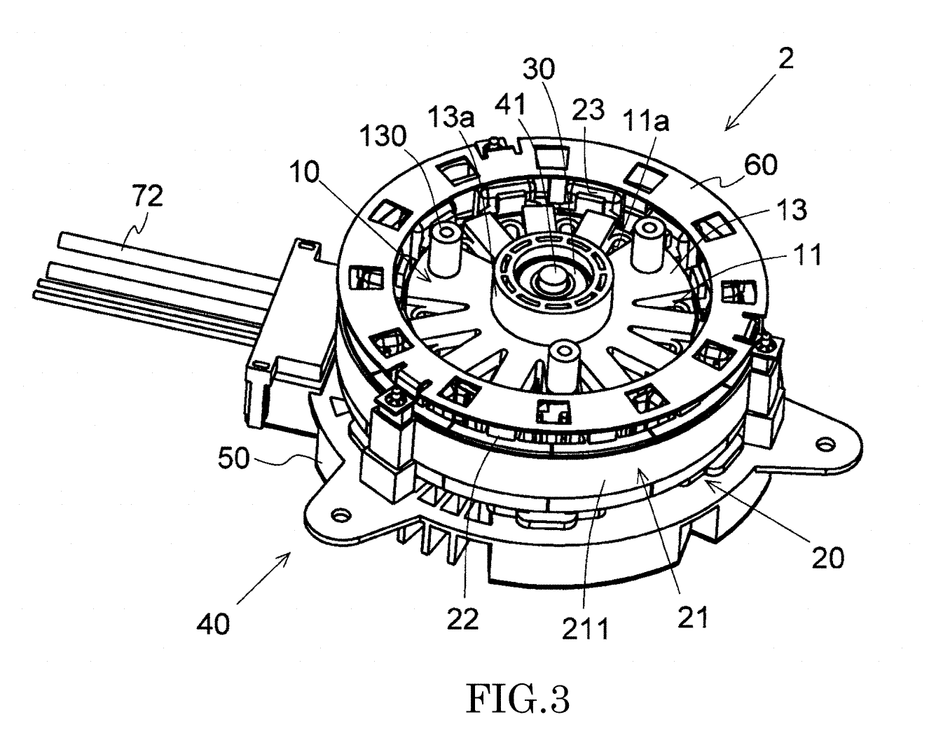

FIG. 3 is a schematic perspective view of the motor 2 according to the present embodiment. FIG. 4 is a schematic sectional view of the motor 2 according to the present embodiment. Specifically, FIG. 4 illustrates a longitudinal section including the central axis A. The motor 2 is a motor of an inner rotor type. The motor 2 includes a rotor 10, a stator 20, a bearing 30, and a holder 40.

The rotor 10 rotates on the central axis A. The rotor 10 includes a rotor core 11, a plurality of magnets 12, and a resin portion 13. In the present embodiment, the rotor core 11 is formed of a stack of magnetic steel sheets. The rotor core 11 may be formed of a plurality of core pieces bonded together. Alternatively, the rotor core 11 may be formed of a powder magnetic core. The rotor core 11 has a plurality of through-holes 11a that penetrate the rotor core 11 in the axial direction. The rotation of the impeller 3 causes air to flow through each through-hole 11a. The motor 2 is thus cooled. In addition, the through-holes 11a in the rotor core 11 contribute to a reduction in weight of the rotor core 11, which improves the efficiency of the motor 2. Each of the magnets 12 is a permanent magnet.

The resin portion 13 is provided to cover at least a part of the rotor core 11. The resin portion 13 is provided to cover at least a part of each magnet 12. The resin portion 13 fixes the magnets 12 to the rotor core 11. However, the magnets 12 may be fixed to the rotor core 11 by any other means in addition to the resin portion 13. For example, the magnets 12 may be fixed to the rotor core 11 with an adhesive.

The stator 20 is located radially outside the rotor 10. The stator 20 includes a stator core 21, insulators 22, and coils 23. In the present embodiment, the stator core 21 is formed of a stack of magnetic steel sheets. Alternatively, the stator core 21 may be formed of a plurality of core pieces bonded together. The stator core 21 has an inner peripheral face that faces an outer peripheral face of the rotor 10. The stator core 21 includes a core back 211 that is formed in a ring or substantially ring shape, and a plurality of teeth 212 that protrude radially inward from the core back 211. The teeth 212 are arranged at equal intervals in the circumferential direction. The teeth 212 are respectively covered with the insulators 22. Each of the insulators 22 is formed of an insulating member (e.g., a resin). The coils 23 are formed of conductive wires wound around the teeth 212 via the insulators 22.

At least one bearing 30 supports the rotor 10 such that the rotor 10 is rotatable with respect to the stator 20. In the present embodiment, the motor 2 includes two bearings 30. In the present embodiment, each of the bearings 30 is a ball bearing. The bearings 30 are spaced apart from each other in the axial direction. The resin portion 13 includes at least one bearing holder 13a that holds a bearing 30. The at least one bearing holder 13a is located radially inside the resin portion 13. In the present embodiment, the number of bearing holders 13a is equal to the number of bearings 30. That is, the number of bearing holders 13a is two. Specifically, the bearing holders 13a are spaced apart from each other and are respectively disposed on axially first and second sides of the resin portion 13. Each bearing 30 may be any other bearing in addition to the ball bearing. Examples of the bearings 30 may include a sleeve bearing and a fluid dynamic bearing.

The holder 40 supports the stator 20. The holder 40 has, on its axially second side, a bracket 50. The bracket 50 is formed in a circular or substantially circular shape as seen in axial plan view. The bracket 50 has, on its central portion, a shaft 41 fixed thereto. The shaft 41 extends in the axial direction. The central axis A coincides with the center of the shaft 41 as seen in axial plan view. The bearing 30 is located between the rotor 10 and the shaft 41. The rotor 10 is rotatable with respect to the shaft 41.

A controller 70 is disposed on an axially second side of the bracket 50. The controller 70 includes a control circuit board 71 on which a control circuit is mounted. In the present embodiment, the control circuit board 71 is disposed perpendicularly to the central axis A. The control circuit board 71 may tilt relative to the central axis A. A plurality of wires 72 are electrically connected to the control circuit board 71. The wires 72 are drawn radially outward from the bracket 50. A lid 80 is disposed on an axially second side of the control circuit board 71. The lid 80 is provided to cover the control circuit board 71. The lid 80 is supported by the bracket 50.

The holder 40 has, on its axially first side, a cover 60. In the present embodiment, the cover 60 is formed of a circular ring-shaped or substantially circular ring-shaped member. The shape of the cover 60 is not particularly limited. For example, the cover 60 may be formed in a polygonal or substantially polygonal shape. The cover 60 is located radially outside the rotor 10 as seen in plan view. Moreover, the cover 60 is disposed on an axially first side of the stator 20 as seen in plan view. The cover 60 is provided to cover the coils 23. The rotor 10 includes at least one protrusion 130 that protrudes beyond the cover 60 toward the axially first side. The tubular portion 4 of the impeller 3 is mounted to the protrusion 130. The impeller 3 thus rotates together with the rotor 10. In the present embodiment, the tubular portion 4 is fixed to the protrusion 130 with a screw 7. Alternatively, the tubular portion 4 may be fixed to the protrusion 130 by any other method such as welding or adhesion. Since the impeller 3 is mounted to the rotor 10 via the protrusion 130, a space through which air flows is defined between the impeller 3 and the rotor 10.

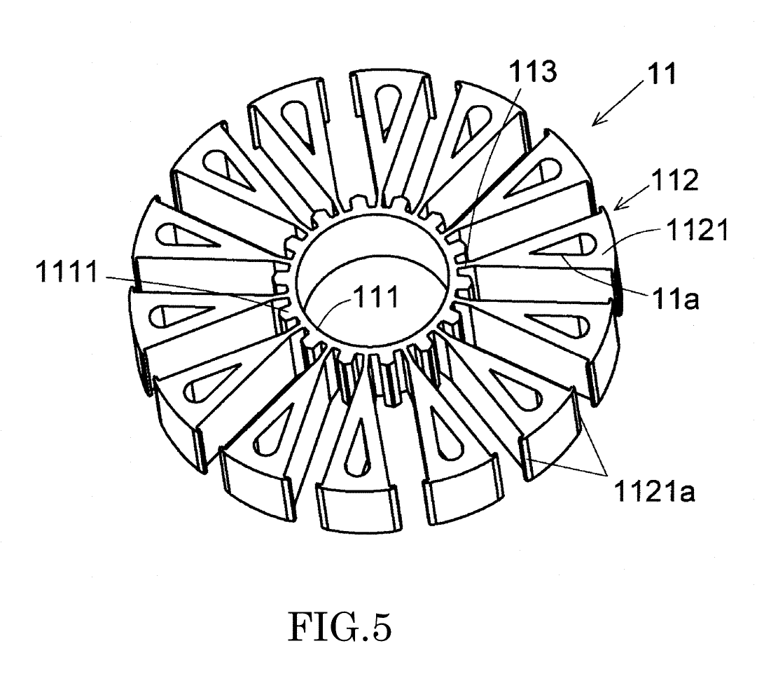

FIG. 5 is a schematic perspective view of the rotor core 11 according to the present embodiment. The rotor core 11 includes an inner core portion 111, an outer core portion 112, and a plurality of connection portions 113. The inner core portion 111 is formed of an annular member that extends in the axial direction. The outer core portion 112 is disposed radially outside the inner core portion 111.

The outer core portion 112 includes a plurality of outer core elements 1121. As seen in axial plan view, each of the outer core elements 1121 is formed in a sector or substantially sector shape. Each of the outer core elements 1121 tapers from its radially outer side toward its radially inner side. In other words, each of the outer core elements 1121 has a circumferential width that gradually narrows inward in the radial direction. The outer core elements 1121 are disposed on an outer periphery of the inner core portion 111 and are arranged at equal intervals in the circumferential direction. In the present embodiment, the number of outer core elements 1121 is 14. However, the number of outer core elements 1121 may be appropriately changed.

Each of the connection portions 113 extends in the radial direction and connects a corresponding one of the outer core elements 1121 to the inner core portion 111. Specifically, each of the connection portions 113 connects a circumferential center of a radially inner-side end of a corresponding one of the outer core elements 1121 to an outer peripheral face of the inner core portion 111. Preferably, each of the connection portions 113 has a circumferential width that is narrow. This configuration suppresses a flow of magnetic flux toward the inner core portion 111. The inner core portion 111, the outer core portion 112, and the plurality of connection portions 113 are formed as a continuous member.

Each of the outer core elements 1121 has the through-hole 11a that penetrates the outer core element 1121 in the axial direction. Each of the through-holes 11a expands in the radial direction. Each of the through-holes 11a partially has a circumferential width that gradually widens outward in the radial direction. In the present embodiment, each of the through-holes 11a is formed in a sector or substantially sector shape as seen in axial plan view. This configuration reduces an amount of magnetic flux flowing from the outer core elements 1121 to the inner core portion 111. The through-holes 11a each having an increased volume allow an increase in amount of air flowing therethrough, so that the motor 2 is further cooled.

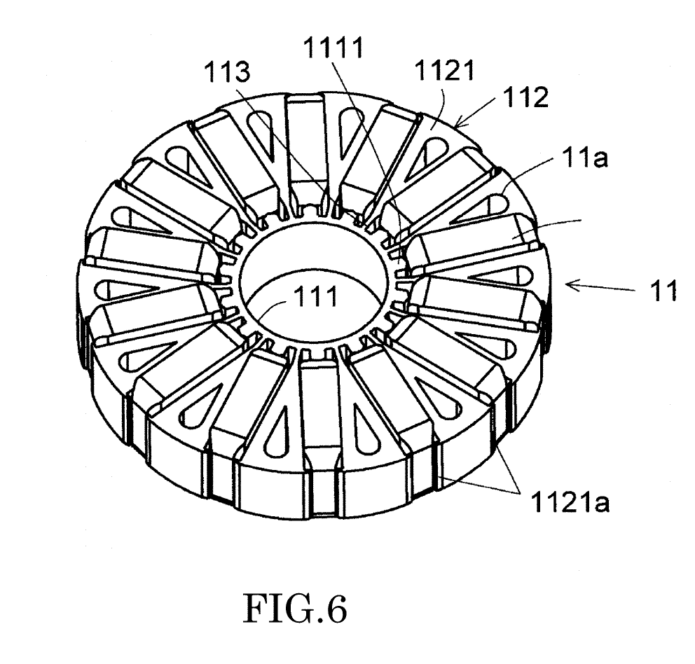

FIG. 6 is a schematic perspective view of the rotor core 11 and the plurality of magnets 12 according to the present embodiment. The magnets 12 are equal or substantially equal in shape and size to one another. In the present embodiment, each of the magnets 12 is formed in a rectangular parallelepiped or substantially rectangular parallelepiped shape. Each magnet 12 is disposed on a clearance between adjoining two of the outer core elements 1121. The magnets 12 are arranged at equal intervals in the circumferential direction in the rotor core 11. In the present embodiment, the number of magnets 12 is 14. However, the number of magnets 12 may be appropriately changed. At least one of an axially first-side end and an axially second-side end of each magnet 12 protrudes from an end face of the rotor core 11 in the axial direction. In the present embodiment, an axially first-side end face of each magnet 12 is located axially above an upper face of the rotor core 11. An axially second-side end face of each magnet 12 is located axially below a lower face of the rotor core 11. This configuration allows an increase in volume of each magnet 12 while suppressing an increase in weight of the rotor core 11, and thus enables an increase in magnetic force.

In the present embodiment, each of the magnets 12 has, on its circumferentially first side, a north-pole main surface and, on its circumferentially second side, a south-pole main surface. The magnets 12 are arranged such that the same magnetic poles face each other in the circumferential direction. Alternatively, the magnets 12 may be arranged such that the north pole and the south pole face each other in the circumferential direction.

The inner core portion 111 includes a plurality of first projections 1111 that protrude outward in the radial direction. The first projections 1111 are located on the outer peripheral face of the inner core portion 111. The first projections 1111 are arranged at equal intervals in the circumferential direction. Each of the first projections 1111 is located between adjoining two of the connection portions 113. Each of the outer core elements 1121 includes a pair of second projections 1121a that protrude in the circumferential direction. The second projections 1121a are located on a radially outer-side end of each outer core element 1121. The magnets 12 have radially inner-side end faces that respectively abut against the first projections 1111. The magnets 12 have radially outer-side end faces that respectively abut against the second projections 1121a. The main surfaces of each magnet 12 are in contact with the outer core elements 1121 in the circumferential direction, the outer core elements 1121 respectively adjoining the main surfaces of each magnet 12. The position of each magnet 12 in the radial and circumferential directions is thus set in the rotor core 11.

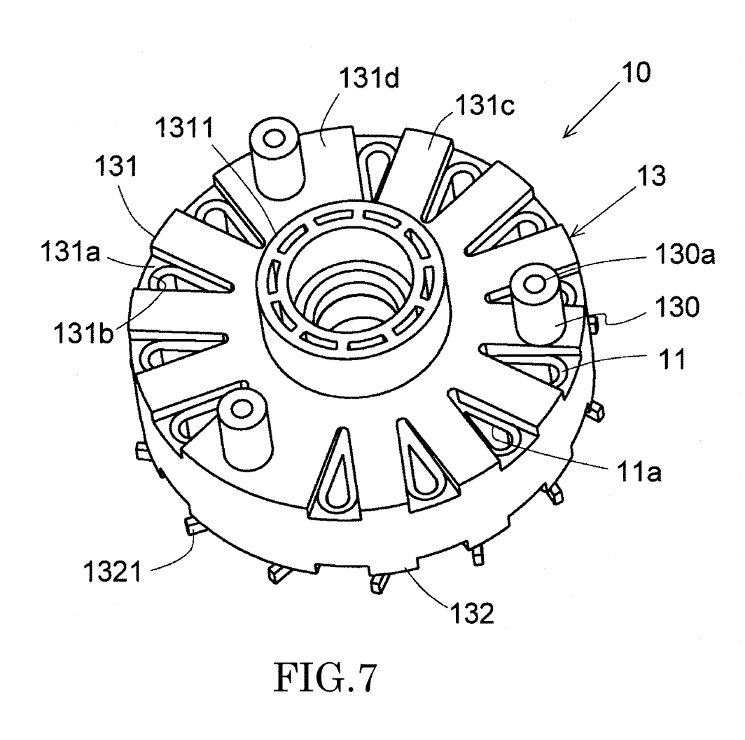

FIG. 7 is a schematic perspective view of the rotor 10 according to the present embodiment as obliquely seen from the axially first side. As illustrated in FIG. 4 and FIG. 7, the resin portion 13 includes a first resin portion 131 that is provided to cover at least a part of an axially first-side end face of the rotor core 11. In the present embodiment, the first resin portion 131 is provided to cover the axially first-side end faces of the magnets 12 in addition to the part of the axially first-side end face of the rotor core 11.

The first resin portion 131 is formed in a ring or substantially ring shape. The first resin portion 131 has, on its radially outer side, a plurality of clearances 131a. Each of the clearances 131a penetrates the first resin portion 131 in the axial direction. Each of the clearances 131a has an opening 131b that is formed in a sector or substantially sector shape as seen in the axial direction. At least one clearance 131a is substantially equal in circumferential position to at least one through-hole 11a. In other words, the through-holes 11a are exposed without being covered with the first resin portion 131 as seen in the axial direction. In the present embodiment, the clearances 131a are formed on the outer periphery of the first resin portion 131. However, this configuration is merely exemplary. Alternatively, a plurality of notches may be formed in the outer periphery of the first resin portion 131 so as to be arranged in the circumferential direction.

In the present embodiment, some of the through-holes 11a are covered with the first resin portion 131. Of the 14 through-holes 11a, specifically, two through-holes 11a are covered with the first resin portion 131. In other words, the remaining 12 through-holes 11a are exposed without being covered with the first resin portion 131. No clearance 131a is formed on the axially first side of each through-hole 11a that is covered with the first resin portion 131.

The first resin portion 131 includes a plurality of narrow portions 131c and a plurality of wide portions 131d. The narrow portions 131c and the wide portions 131d are located on a radially outer side of the first resin portion 131. Each narrow portion 131c is sandwiched between adjoining two of the clearances 131a, and each wide portion 131d is also sandwiched between adjoining two of the clearances 131a. The narrow portions 131c are different in circumferential width from the wide portions 131d. Specifically, the wide portions 131d are larger in circumferential width than the narrow portions 131c. In the present embodiment, the number of narrow portions 131c is 10. The number of wide portions 131d is two. The two wide portions 131d are located between the seven narrow portions 131c consecutively arranged in the circumferential direction and the three narrow portions 131c consecutively arranged in the circumferential direction.

The first resin portion 131 includes a tubular resin portion 1311 that extends toward the axially first side. The tubular resin portion 1311 is located on a radially inner side of the first resin portion 131. The bearing 30 located on the axially first side is fit by press into the tubular resin portion 1311. The tubular resin portion 1311 constitutes the bearing holder 13a.

The first resin portion 131 includes at least one protrusion 130 that protrudes toward the axially first side. In the present embodiment, the number of protrusions 130 is three. The three protrusions 130 are arranged at equal intervals in the circumferential direction. Of the three protrusions 130, one protrusion 130 is formed on one of the narrow portions 131c, and the remaining two protrusions 130 are respectively formed on the two wide portions 131d. The protrusion 130 on the narrow portion 131c overlaps with the magnet 12 that adjoins the protrusion 130, as seen in axial plan view. The protrusions 130 on the wide portions 131d overlap with the through-holes 11a that respectively adjoin the protrusions 130, as seen in axial plan view. In other words, the protrusion 130 on the narrow portion 131c is substantially equal in circumferential position to one of the magnets 12. In the present embodiment, each of the protrusions 130 is formed in a columnar or substantially columnar shape. Each of the protrusions 130 has, on its central portion, a hole 130a that extends in the axial direction. Each of the holes 130a is a screw hole. With regard to the protrusions 130, the number, arrangement, and shape are merely exemplary and may be appropriately changed.

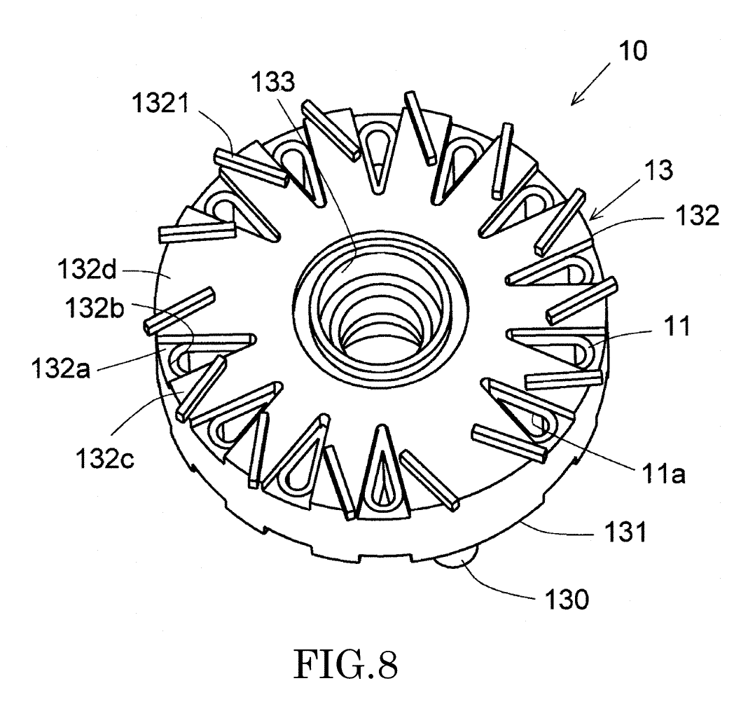

FIG. 8 is a schematic perspective view of the rotor 10 according to the present embodiment as obliquely seen from the axially second side. The resin portion 13 includes a second resin portion 132 that is provided to cover at least a part of an axially second-side end face of the rotor core 11. In the present embodiment, the second resin portion 132 covers the axially second-side end faces of the magnets 12 in addition to the part of the second axial-side end face of the rotor core 11.

The second resin portion 132 is formed in a ring or substantially ring shape. The second resin portion 132 has a plurality of clearances 132a. Each of the clearances 132a penetrates the second resin portion 132 in the axial direction. Each of the clearances 132a has an opening 132b that is formed in a sector or substantially sector shape as seen in the axial direction. At least one clearance 132a is substantially equal in circumferential position to at least one through-hole 11a. In other words, the through-holes 11a are exposed without being covered with the second resin portion 132 as seen in the axial direction. Each of the clearances 132a is disposed opposite a corresponding one of the clearances 131a of the first resin portion 131 in the axial direction. In other words, the clearances 132a are equal in circumferential position to the clearances 131a. Of the 14 through-holes 11a, two through-holes 11a are covered with the second resin portion 132. The remaining 12 through-holes 11a are exposed without being covered with the second resin portion 132.

As in the first resin portion 132, the second resin portion 132 includes a plurality of narrow portions 132c and a plurality of wide portions 132d. The narrow portions 132c and the wide portions 132d are formed on a radially outer side of the second resin portion 132. Each narrow portion 132c is sandwiched between adjoining two of the clearances 132a, and each wide portion 132d is also sandwiched between adjoining two of the clearances 132a. The narrow portions 132c are different in circumferential width from the wide portions 132d. Specifically, the wide portions 132d are larger in circumferential width than the narrow portions 132c. The narrow portions 132c and the wide portions 132d are respectively disposed opposite the narrow portions 131c and the wide portions 131d of the first resin portion 131 in the axial direction. In other words, the narrow portions 132c are equal in circumferential position to the narrow portions 131c. Moreover, the wide portions 132d are equal in circumferential position to the wide portions 131d. In the present embodiment, the number of narrow portions 132c is 10. The number of wide portions 132d is two.

The second resin portion 132 includes at least one rib 1321 that protrudes toward the axially second side. This configuration enables a change in air flow to be generated upon rotation of the impeller 3 and also enables an increase in amount of air flowing through each through-hole 11a. In the present embodiment, the rib 1321 is formed in a quadrangular prism or substantially quadrangular prism shape. However, the shape of the rib 1321 is not particularly limited. Examples of the shape of the rib 1321 may include a polygonal prism or substantially polygonal prism shape, a columnar or substantially columnar shape, and a plate or substantially plate shape. The rib 1321 extends obliquely with respect to the radial direction as seen in the axial direction. The rib 1321 is disposed on the outer periphery of the second resin portion 132 in the radial direction. In the present embodiment, the second resin portion 132 includes a plurality of ribs 1321. The ribs 1321 are arranged at equal or substantially equal intervals in the circumferential direction. In the present embodiment, one rib 1321 is provided for each narrow portion 132c, and two ribs 1321 are provided for each wide portion 132d. Each of the ribs 1321 has a radially outer end that protrudes radially outward from an outer peripheral face of the second resin portion 132 formed in a ring or substantially ring shape.

The ribs 1321 respectively adjoin the through-holes 11a arranged in the circumferential direction. Each of the ribs 1321 is gradually close to a corresponding one of the through-holes 11a from a radially outer side to radially inner side thereof as seen in axial plan view, the corresponding through-hole 11a being located forward of each rib 1321 in a rotation direction of the rotor 10. The ribs 1321 thus direct an air flow, which is generated upon rotation of the rotor 10, to the corresponding through-holes 11a. In other words, the ribs 1321 allow a larger amount of air to flow through the corresponding through-holes 11a, so that the interior of the motor 2 is further cooled. In the present embodiment, the impeller 3 rotates in a counterclockwise direction in FIG. 1 with respect to the through-holes 11a. In other words, the rotor 10 rotates in a clockwise direction in FIG. 8. In this case, the impeller 3 rotates together with the rotor 10 to cause air to flow in the clockwise direction. In FIG. 8, the above-described through-hole 11a located forward of each rib 1321 in the rotation direction of the rotor 10 refers to the through-hole 11a that adjoins the clockwise side of the corresponding rib 1321. In FIG. 8, each of the ribs 1321 is gradually close to a corresponding one of the through-holes 11a from a radially outer side to radially inner side thereof, the corresponding through-hole 11a being located on the left of each rib 1321. In the case where the rotor 10 rotates in the reverse direction, the ribs 1321 tilt in the reverse direction. In the case where the rotor 10 rotates in a counterclockwise direction in FIG. 8, the above-described through-hole 11a located forward of each rib 1321 in the rotation direction of the rotor 10 refers to the through-hole 11a that adjoins the counterclockwise side of the corresponding rib 1321. In this case, each of the ribs 1321 is gradually close to a corresponding one of the through-holes 11a from a radially outer side to radially inner side thereof, the corresponding through-hole 11a being located on the right of each rib 1321.

The ribs 1321 are equal or larger in number to or than through-holes 11a that are disposed at a position displaced from the resin portion 13 and are exposed from the resin portion 13. In the present embodiment, of the 14 through-holes 11a formed in the rotor core 11, 12 through-holes 11a are exposed without being covered with the first resin portion 131 and the second resin portion 132. In other words, the rotor 10 has 12 through-holes 11a that are disposed at a position displaced from the resin portion 13 and are exposed from the resin portion 13. On the other hand, the number of ribs 1321 is 14. The ribs 1321 are larger in number than the through-holes 11a exposed from the resin portion 13. The ribs 1321 thus direct a larger amount of air in a predetermined direction to feed a larger amount of air to the corresponding through-holes 11a. Therefore, the motor 2 is further cooled.

As illustrated in FIG. 4, the resin portion 13 includes a third resin portion 133 that is located on an inner periphery of the resin portion 13 in the radial direction and is provided to cover an inner peripheral face of the rotor core 11. The third resin portion 133 connects the first resin portion 131 to the second resin portion 132. The third resin portion 133 includes the bearing holder 13a that is located on an axially second-side end of the third resin portion 133 and is provided to hold the bearing 30 disposed on the axially second side. Preferably, the resin portion 13 is provided to cover an outer peripheral face of the rotor core 11 and outer peripheral faces of the magnets 12. The resin portion 13 thus prevents the magnets 12 from coming off the rotor 10 during rotation of the rotor 10.

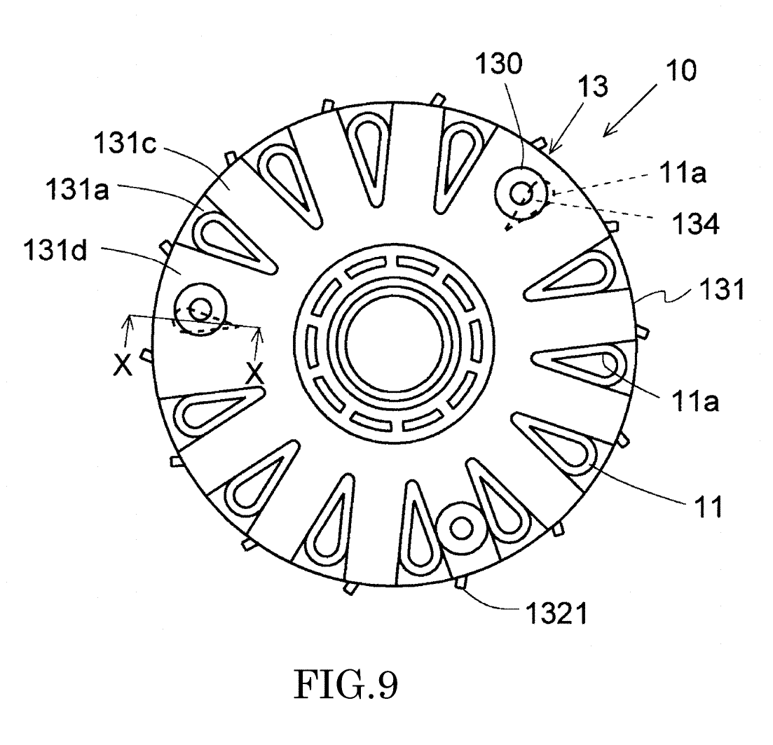

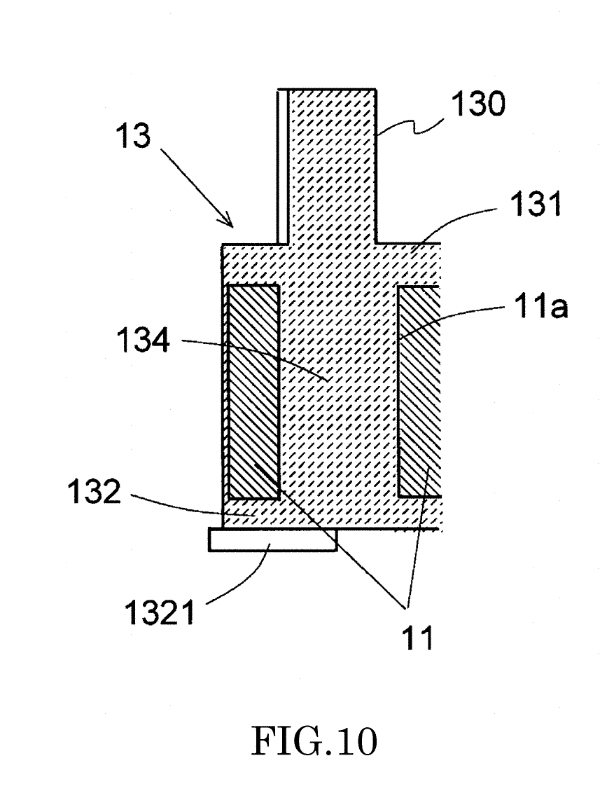

FIG. 9 is a schematic plan view of the rotor 10 according to the present embodiment as seen from the axially first side. FIG. 10 is a schematic sectional view taken along line X-X in FIG. 9. As illustrated in FIG. 9 and FIG. 10, the resin portion 13 includes an extension 134. The extension 134 is provided in at least one of the through-holes 11a. The extension 134 extends from the first resin portion 131 through the through-hole 11a in the axial direction. In FIG. 9, a broken line shows the through-hole 11a and the extension 134 that are not seen since they are covered with the first resin portion 131.

In the present embodiment, two through-holes 11a are each provided with an extension 134. The two through-holes 11a are respectively covered with the wide portions 131d of the first resin portion 131. In the present embodiment, at least a part of each extension 134 is disposed opposite or is in contact with an inner face of the corresponding through-hole 11a in a direction perpendicular to the axial direction. In other words, the extensions 134 are approximately equal in shape and size to the through-holes 11a as seen in axial plan view. However, this configuration is merely exemplary. For example, the extensions 134 may be different in shape from the through-holes 11a as seen in axial plan view. Alternatively, the extensions 134 may be smaller in size than the through-holes 11a as seen in axial plan view.

As illustrated in FIG. 10, each extension 134 extends from the first resin portion 131 to the second resin portion 132 through the corresponding through-hole 11a. In other words, each extension 134 connects the first resin portion 131 to the second resin portion 132. However, this configuration is merely exemplary. For example, each extension 134 extending from the first resin portion 131 does not necessarily reach the second resin portion 132. In other words, the distal end of each extension 134 extending from the first resin portion 131 may be located inside the corresponding through-hole 11a. Alternatively, each extension 134 may extend from the second resin portion 132 to the first resin portion 131 through the corresponding through-hole 11a. Also in this case, each extension 134 extending from the second resin portion 132 does not necessarily reach the first resin portion 131. In other words, the distal end of each extension 134 extending from the second resin portion 132 may be located inside the corresponding through-hole 11a.

As illustrated in FIG. 9, each protrusion 130 and the corresponding extension 134 overlap with each other as seen in axial plan view. In the present embodiment, each protrusion 130 and the corresponding extension 134 do not entirely overlap with each other as seen in axial plan view. Apart of each protrusion 130 lies off the corresponding extension 134. In other words, each protrusion 130 is positionally displaced from the corresponding extension 134 in at least either the circumferential direction or the radial direction. However, each extension 134 may entirely overlap with the corresponding through-hole 11a as seen in axial plan view. In other words, each protrusion 130 may be positionally equal to the corresponding extension 134 in both the circumferential direction and the radial direction.

In the present embodiment, of the three protrusions 130, two protrusions 130 overlap with the corresponding extensions 134 and the remaining one extension 134 does not overlap with the corresponding extension 134 as seen in axial plan view. The remaining one protrusion 130 overlaps with the magnet 12 that adjoins the protrusion 130, as seen in axial plan view. However, this configuration is merely exemplary. For example, at least one of the protrusions 130 may overlap with the corresponding extension 134 as seen in axial plan view. Alternatively, all the protrusions 130 may overlap with the corresponding extensions 134 as seen in axial plan view.

In the present embodiment, each extension 134 increases an axial thickness of the resin portion 13 at a position where the corresponding protrusion 130 is disposed. In other words, each extension 134 causes an increase in stiffness at the position of the corresponding protrusion 130 in the resin portion 13. The extensions 134 extend from the first resin portion 131 to the second resin portion 132. This configuration further increases the stiffness at the positions of the protrusions 130 in the resin portion 13. The impeller 3 is mounted to the protrusions 130. In the present embodiment, the stiffness is improved at the region where the impeller 3 is mounted in the resin portion 13. Therefore, the impeller 3 is firmly fixed to the protrusions 130. The electric fan 1 thus reduces occurrence of wobbling at the impeller 3 relative to the rotor 10. The reduction in occurrence of wobbling at the impeller 3 relative to the rotor 10 leads to a reduction in noise due to wobbling of the impeller 3. The reduction in occurrence of wobbling at the impeller 3 also causes the rotor 10 to rotate with good positional accuracy with respect to the stator 20, which enhances the efficiency of the electric fan 1.

Preferably, at least a part of each protrusion 130 overlaps with a region where each through-hole 11a has a maximum circumferential width as seen in axial plan view. According to this configuration, the protrusions 130 are disposed on the region where the circumferential widths are larger and the stiffness is increased, at the positions of the resin portion 13 whose axial thickness is increased. Therefore, the impeller 3 is firmly fixed to the protrusions 130.

In the present embodiment, the motor 2 has the plurality of through-holes 11a that are not closed by the resin portion 13. Therefore, when the impeller 3 rotates, air flows through the through-holes 11a from the axially second side toward the axially first side. This air flow cools the interior of the motor 2. The ribs 1321 of the resin portion 13 enable an increase in amount of air flowing through the through-holes 11a, so that the motor 2 is cooled efficiently. The motor 2 according to the present embodiment improves the stiffness of the region where the impeller 3 is mounted while ensuring the cooling performance.

The present disclosure is not limited to the embodiment described above and may be modified variously. For example, the bracket 50 and the cover 60 may be integrated with each other. The shaft 41 is not necessarily fixed to the bracket 50. For example, the shaft 41 may rotate together with the rotor 10. In this case, the shaft 41 may be fixed to, for example, the third resin portion 133. The bearings 30 may be fixed to, for example, the bracket 50 and the cover 60. The second resin portion 132 is not necessarily provided with the ribs 1321.

An embodiment of the present disclosure is applicable to, for example, an electric fan that cools a coolant for an automobile.

Features of the above-described embodiments and the modifications thereof may be combined appropriately as long as no conflict arises.

While embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor that rotates on a central axis; and
a stator that is located radially outside the rotor,
wherein
the rotor comprises:
a rotor core; and
a resin portion that is provided to cover at least a part of the rotor core,
the rotor core comprises a plurality of through-holes that penetrate the rotor core in an axial direction,
the resin portion comprises:
a first resin portion that is provided to cover at least a part of an axially first-side end face of the rotor core; and
an extension that is provided in at least one of the through-holes and extends from the first resin portion through the through-hole in the axial direction,
the first resin portion comprises a protrusion that protrudes toward an axially first side, and
the protrusion and the extension overlap with each other as seen in an axial plan view.

2. The motor according to claim 1, wherein
the resin portion further comprises a second resin portion that is provided to cover at least a part of an axially second-side end face of the rotor core, and
the extension connects the first resin portion to the second resin portion.

3. The motor according to claim 2, wherein
the second resin portion comprises a rib that protrudes toward an axially second side.

4. The motor according to claim 3, wherein
as seen in the axial plan view,
each of the through-holes expands in a radial direction,
the rib extends obliquely with respect to the radial direction, and
the rib becomes closer to a corresponding one of the through-holes from a radially outer side to radially inner side thereof, the corresponding through-hole being located forward of the rib in a rotation direction of the rotor.

5. The motor according to claim 3, wherein
the second resin portion comprises a plurality of the ribs
a number of the ribs greater than or equal to a number of through-holes that are disposed at a position displaced from the resin portion and are exposed from the resin portion.

6. The motor according to claim 1, wherein
each of the through-holes partially has a circumferential width that gradually widens outward in a radial direction, and
at least a part of the protrusion overlaps with a region where each through-hole has a maximum circumferential width as seen in axial plan view.

7. An electric fan comprising:
the motor according to claim 1; and
an impeller that is mounted to the motor via the protrusion.
